(19) United States
(12) Patent Application Publication
(10) Pub. No.: US 2004/0204981 A1
(43) Pub. Date: Oct. 14, 2004

(54) Business method for performing consumer research

(76) Inventors: Diane M. Schuebel, Racine, WI (US); Kitty Knecht, Evanston, IL (US)

Correspondence Address: S.C. JOHNSON & SON, INC., 1525 HOWE STREET, RACINE, WI, 53403-2236, US

(21) Appl. No.: 10/413,055

(22) Filed: Apr. 14, 2003

(51) Int. Cl. G06F 17/60

(52) U.S. Cl. 705/10

(57) ABSTRACT

A marketing method comprises categorizing consumers based on their buying profile and transmitting tailored advertisements to each of those categories. The method includes the steps of completing an on-line questionnaire, assigning numerical values to answers provided by the consumer, performing arithmetic calculations based on those answers, and comparing the results of those arithmetic calculations to determine which of a plurality of categories applies to the consumer. Depending on the category of the consumer, a different advertisement tailored to the specific buying profile of that category can be transmitted, such as by electronic mail, back to the consumer. A web-based marketing system carries out this method.

### FIELD OF THE DISCLOSURE

The disclosure generally relates to business methods and, more particularly, relates to methods for performing consumer research and classifying consumers into buying trend categories.

### BACKGROUND OF THE DISCLOSURE

Providers of goods and services are continually striving to improve the manner with which they market their wares. Success or failure in the chosen marketing campaign or strategy directly translates to increased or decreased demand and sales for the goods and services of the provider.

A number of advertising or marketing strategies are therefore available. Advertisements to the public as a whole can generate brand name recognition and generate overall good will for the provider, but must be relatively broad-brush and simple in approach. Examples of such advertisements are billboards and blimps, devices which disseminate a message to the public without regard to the individual backgrounds of the consumers viewing the advertisements.

It is often more desirable to tailor an advertisement to a specific group having similar interests and needs. If the background of an audience is known, the message can be more specific and directed to those known concerns. An example of such a situation is the advertising found in trade journals and the like, i.e., publications which are only read by a very specialized segment of the population. For example, a medical device provider may be well served to tailor an advertisement and place the advertisement directly within the journal of the American Medical Association or other publication likely to be read by the Medical community. Similarly, advertisements for court reporting services are logically placed within periodic publications of certain bar associations and other similar publications.

A more difficult audience to reach is that of the consumer of general consumer products. For example, providers of cleaning products and personal grooming products generally have the entire population as an audience. The buying tendencies of those consumers will necessarily differ. For example, while generalizations, relatively young consumers may be more concerned with brand name than quality, while relatively older consumers may be mostly concerned about price and/or quality. However, as there is no one medium such as the aforementioned trade journal to reach each of those consumers, it is typical to advertise for such goods on broadly disseminated media such as television and radio.

Even within such broadly disseminated advertisements, however, certain peculiarities of the audience can be identified and the commercial aired can be somewhat tailored to that group. For example, using the aforementioned examples, if a relatively young demographic is the intended audience, the advertisement can appeal to relatively trendy things, whereas advertisements for older consumers can be more factual and pragmatic in their approach. In addition, to increase the likelihood of having the particular advertisement reach the intended audience, the advertisement can be aired during programming known to have an audience share including a large portion of the intended demographic group.

However, the above examples are really only generalities in that it is inaccurate to say each person within a specific demographic will have the same buying preferences. Accordingly, the impact of such advertisements is unpredictable at best. It would therefore be beneficial to provide a marketing system which is capable of identifying the buying profile of each individual consumer, and then provide an advertisement specifically tailored to the wants and needs of that individual consumer. It would be further beneficial if not only those consumers likely to buy a particular type of product could be identified, but if those likely to be loyal to particular brand name could be identified as well.

### SUMMARY OF THE DISCLOSURE

In accordance with one aspect of the disclosure, a method of determining the buying profile of a consumer is disclosed which may comprise asking a series of questions of a consumer wherein each of the questions is asked and answered electronically, assigning a numerical value to each of the answers, multiplying each numerical value by one of a plurality of coefficients to arrive at a product with each coefficient being associated with a particular question and one of a plurality of classification functions, adding the products associated with each classification function together to arrive at a plurality of classification functions sums, adding a constant to each of the classification function sums to arrive at a plurality of classification function values, and comparing the classification function values to determine the buying profile of the consumer.

In accordance with another aspect of the disclosure, a marketing method is disclosed which comprises having consumers complete an on-line questionnaire, classifying each consumer into one of a plurality of categories based on answers received in response to the questions, preparing an advertisement specific to each category, and disseminating the advertisement specific to each category of consumers by electronic mail.

In accordance with another aspect of the disclosure, a marketing system is disclosed which comprises a web server adapted to interact with on-line consumers, a first memory operatively associated with a web server having a consumer questionnaire stored therein, a second memory operatively associated with the web server and having classification software stored therein, a third memory operatively associated with the web server and having a plurality of coefficients stored therein, and a processor operatively associated with the web server, first memory, second memory, and third memory. The processor may be adapted to receive signals from the web server associated with answers provided by on-line consumers in response to the questionnaire stored in the first memory, and execute the software stored in the second memory using the coefficients stored in the third memory to classify the consumer into one of a plurality of consumer categories.

In accordance with another aspect of the disclosure, a marketing method is disclosed which may include receiving information regarding an individual consumer, performing a series of arithmetic functions based on the received information, comparing and contrasting values obtained from the arithmetic functions to determine whether the consumer is one of a high potential consumer, low potential consumer, and deal prone consumer, and transmitting an advertisement to the consumer if the consumer is one of a high potential consumer or deal prone consumer.

These and other aspects and features of the disclosure will become more readily apparent upon reading the following detailed description when taken in conjunction with the accompanying drawings.

### BRIEF DESCRIPTION OF THE DRAWINGS

FIG. 1 is a schematic representation of a marketing system constructed in accordance with the teachings of the disclosure;

FIG. 2 is a flow chart depicting the overall business method of the present disclosure;

FIG. 3 is a flow chart depicting more detailed steps used in classifying consumers according to the business method of the present disclosure;

FIGS. 4a & 4b are sample demographic components of a questionnaire according to the present disclosure;

FIG. 5 is a sample attitudinal component of a questionnaire according to the present disclosure;

FIG. 6 is a spreadsheet depicting a sample series of calculations according to the present disclosure; and

FIG. 7 is a flowchart depicting comparison logic used in determining consumer categories according to the disclosure.

While the present disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the present disclosure as defined by the appended claims.

### DETAILED DESCRIPTION OF THE DISCLOSURE

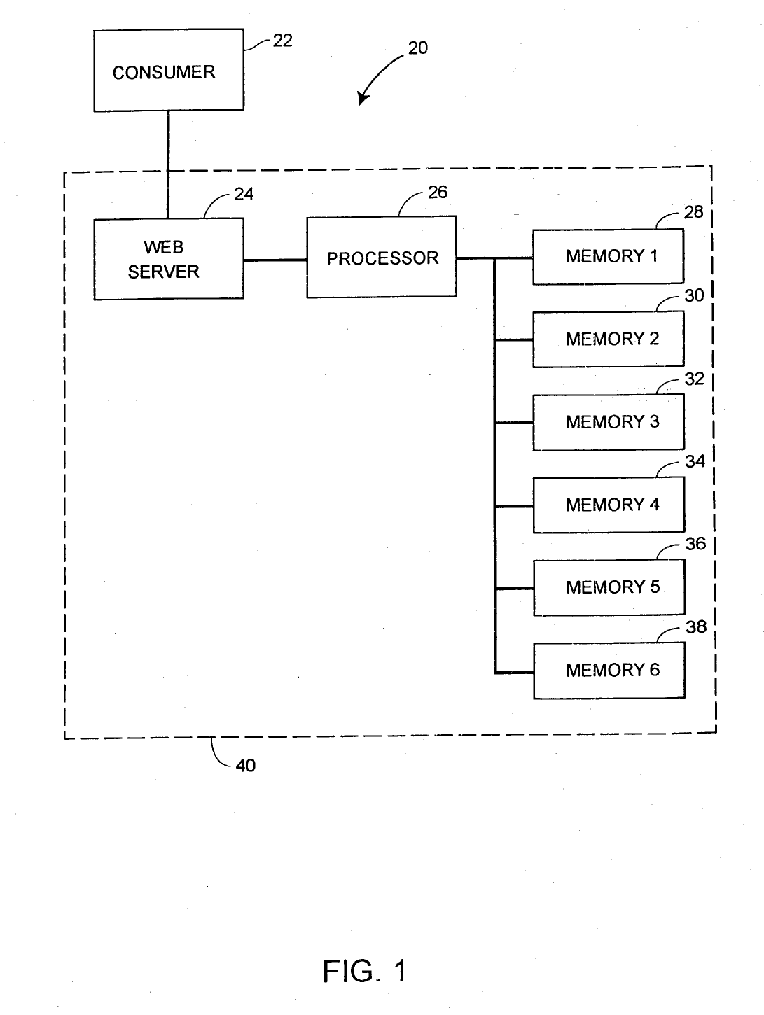

Referring now to the drawings, with specific reference to FIG. 1, a marketing system constructed in accordance with the teachings of the disclosure is generally referred by reference numeral 20. While the system 20 is depicted as being in communication with only a single consumer 22, given the capabilities of the Internet, it will be readily understood by one of ordinary skill in the art that the system 20 can in fact be used in conjunction with an infinite number of consumers.

The system 20 may include a web server 24 providing input/output capability for communicating with the consumer 22 and transmitting signals to and from the consumer to a computer processor 26 also forming part of the system 20. It can be further noted from FIG. 1 that the processor 26 is in communication with any number of memories with six different memory areas 28-38 being depicted. As described in further detail herein, the first memory 28 may be used to store a consumer questionnaire, the second memory 30 may be used to store software used for classifying the consumers, third memory 32 may be used for storing a plurality of coefficients for the use by the software, fourth memory 34 may be used for storing a plurality of numerical constants also used by the software, fifth memory 36 may be used for storing a plurality of advertisements, and sixth memory 38 may be used for storing a plurality of electronic mail addresses.

While the system 20 is depicted schematically as including a web server 24 separate from the processor 26, it is to be understood that any conventional computer device 40, including but not limited to stand-alone personal computers, may be employed to execute the software described herein and communicate with the consumer. Accordingly, most readily available computer devices are sufficient provided that they are web-enabled by way of cable, modem, local area network (LAN), wide area network (WAN), or the like.

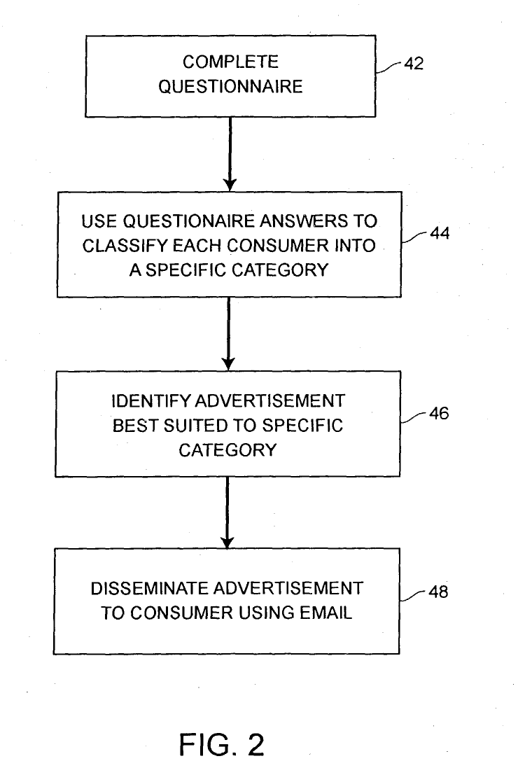

Using the aforementioned structure, a method of classifying consumers into specific categories and then tailoring advertisements to each of those categories can be created. Referring now to FIG. 2, an overall flow chart depicting the system in general is provided. As shown therein, a first step 42 may be to have the consumer complete a questionnaire so as to provide the system 20 with data necessary for computing the appropriate classification. In order to do so, the consumer 22 may access a web site of the goods or services provider by way of the web server 24 and then in conjunction with the processor 26 access the questionnaire stored in the first memory 28. In so doing, it can be seen that the consumer 22 will be able to access and answer the questionnaire electronically. Once the questionnaire is completed, the answers provided by the consumer 22 can be used by the processor 26, running the software stored in the second memory 30, to classify each of the consumers accessing the web site into a specific consumer category. This is depicted as step 44 in FIG. 2. In alternative embodiments, it is possible for the questionnaire to be completed manually, and for the calculation described herein to be computed manually as well.

Once each consumer is classified into a given category, the processor 26 can identify an advertisement stored in the fifth memory 36 best suited for optimizing the potential of gaining the business of the consumer 22. This step is depicted as reference numeral 46 in FIG. 2. As identified in a fourth step 48, the advertisement is then disseminated to the consumer 22 again using the web server 24 to transmit an electronic mail message to the consumer. In so doing, it can be seen that consumers are provided with an advertisement specifically tailored to type of consumer in question, with the advertisements being provided directly to that consumer, as opposed to conventional advertising methods wherein advertisements of a general nature are broadcast to a relatively broad demographic group in the hope that the message eventually reaches the intended consumer.

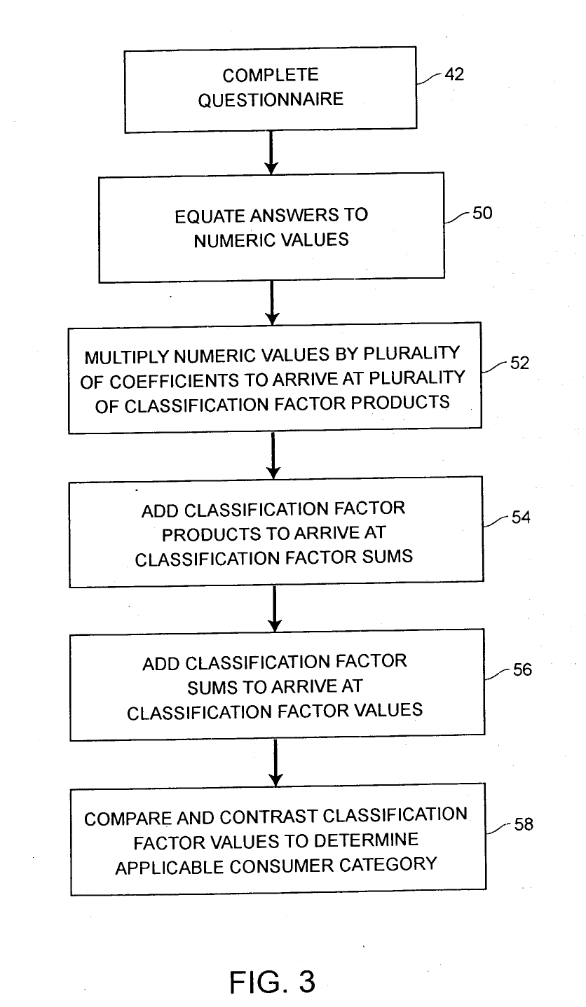

Now in reference to FIG. 3, a more detailed description of the steps which may be taken by the system 20 for classifying each of the consumers 22 into one of a plurality of consumer categories will be provided. In another words, the following will more specifically flesh out the functions and operation of step 44 of FIG. 2. In the example that follows, it is to be understood that different numbers of questions may be used, and different numbers of resulting consumer categories may be reached, and still be within the scope of the present disclosure. However, in the depicted and described embodiment, it is the intent of the system 20 to use the information gathered about the consumer to eventually classify the consumer into one of three consumer categories: deal prone, high potential, and low potential.

The consumer categories are defined herein as follows. A “deal prone” consumer is one who places primary buying importance on the price of the product. A “high potential” consumer is one who is relatively more likely to spend, and thus consumes an above-average amount of product, particularly of the product offered by the provider of the system 20. A “low potential” consumer is one who is relatively disinclined to spend, and thus consumes a below-average amount of product, particularly of the product offered by the provider of the system 20. Put another way, a “high potential” consumer maximizes spending and resources, a “low potential” consumer minimizes spending and resources, and a “deal prone” consumer selectively spends for resources. By classifying each consumer into one of these three categories, advertisements can then be directed primarily to those in the “high potential” category, with certain, likely coupon or discount based, advertisements being directed to the “deal prone” category.

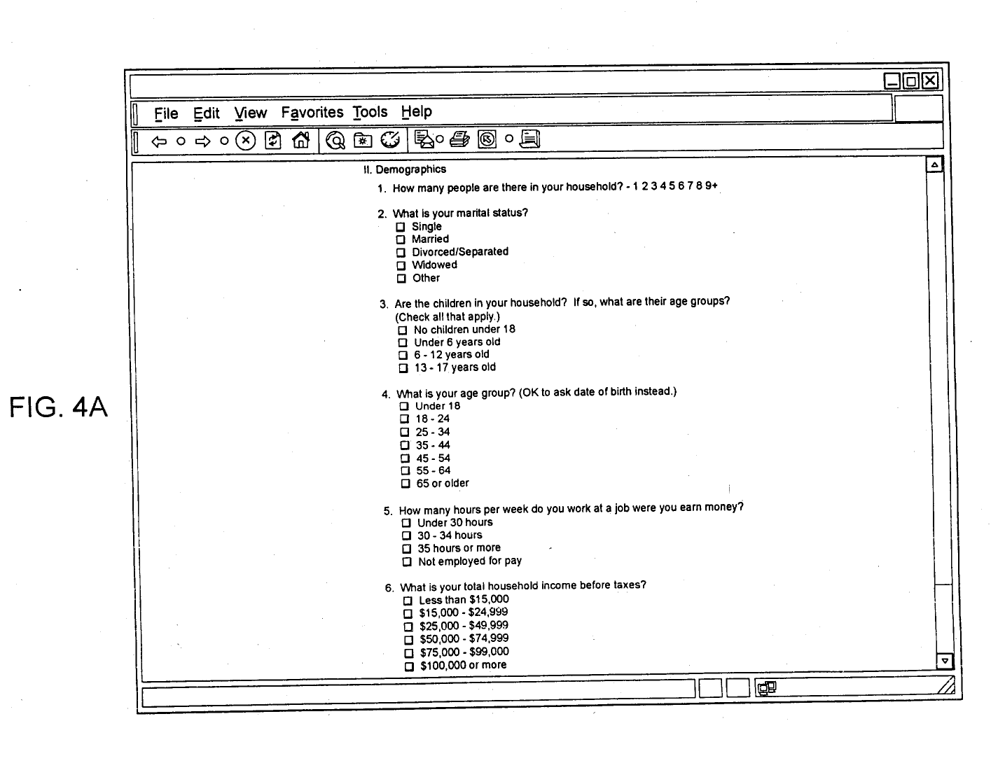

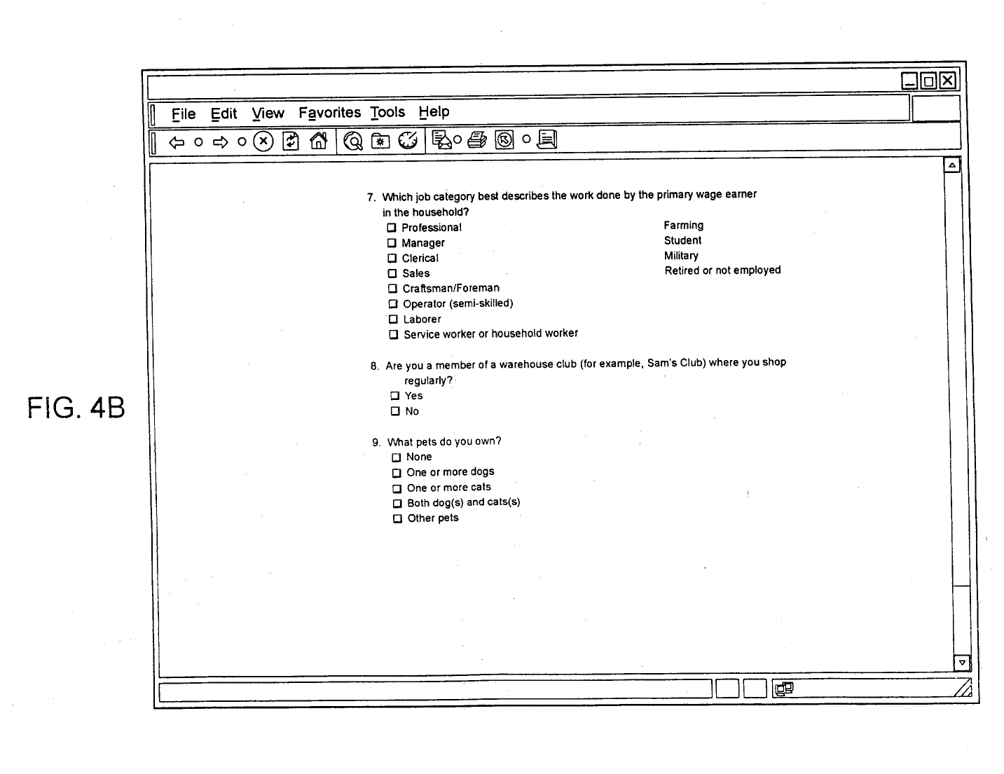

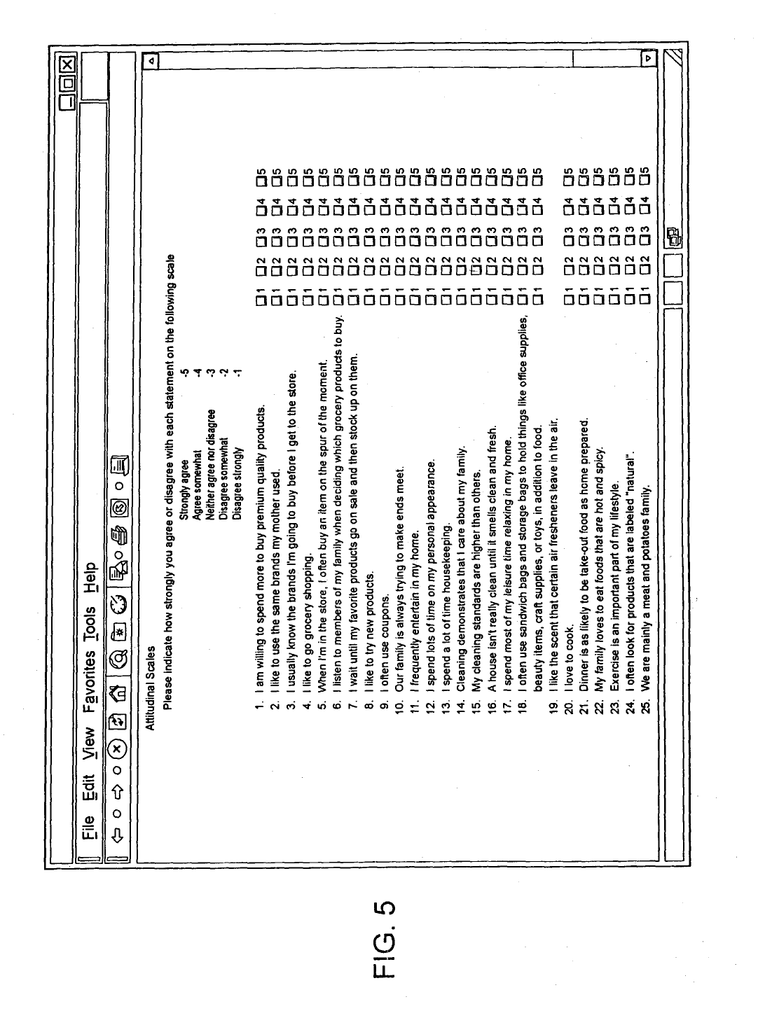

With that being said, in accordance with one embodiment of the present disclosure, step 41 requires a consumer to complete a questionnaire consisting of twenty-five different attitudinal questions, and nine demographic questions, examples of which are provided in FIGS. 4 and 5 respectively. As shown as a step 50 in FIG. 3, each answer provided by the user is then equated to a specific numerical value and stored in one of the memories of the system 20. For example, with each of the attitudinal questions, a range of answers is possible such as those extending from “often” to “rarely.” This may most easily be effectuated by assigning a value of one to five, for example, in response to a question such as “I frequently entertain in my home” wherein five represents a high or often answer and one represents a low or rarely answer.

A step intermediate the assigning of numerical values to the provided answers and the determination of the appropriate consumer category is the calculation of a number of classification function values. The classification function values are then compared and contrasted to determine the appropriate consumer category. In the depicted and described embodiment, eleven classification functions are employed, but in alternative embodiments it is to be understood that a different number of classification functions, or different actual classification functions, can be used. However, the eleven described herein include deal prone, not deal prone, heavy meta user, medium meta user, light meta user, high product line one 1 SOR, low product line 1 SOR, high product line 2 SOR, low product line 2 SOR, high product line 3 SOR, and low product line 3 SOR.

Definitions for each of those eleven classifications functions will now be provided. The “deal prone” classification function tries to determine if the consumer is of the type likely to base purchases primarily on price, whereas a “not deal prone” consumer is one wherein price is not of the primary importance. With regard to each of the meta categories, a “meta consumer” is one who is likely to consume products across a range of product lines offered by a specific provider. For example, if a provider manufactures home cleaning products, air care products, and home storage products, the meta category differentiates between heavy, medium, and light meta consumers. A “heavy meta” user is a consumer likely to buy a large amount of product across all product lines of the provider, while a “light meta” user consumes relatively few products across those product lines, and a “medium meta” user is one consuming an average number of products of the provider. “SOR” is an acronym for “share of requirements” and tries to quantify whether, within a specific type of product line, the user is likely to purchase the specific product of the producer, as opposed to a competitive product. Accordingly, “high product line 1 SOR” means a consumer that is loyal to the brand of the provider at least with respect to a first type of product of the provider. Conversely, “low product line 1 SOR” is a consumer with relatively little loyalty to the brand of the provider in that same product line. The remaining classification functions are similar but address the relative degree of loyalty of the consumer with respect to other product lines of the provider.

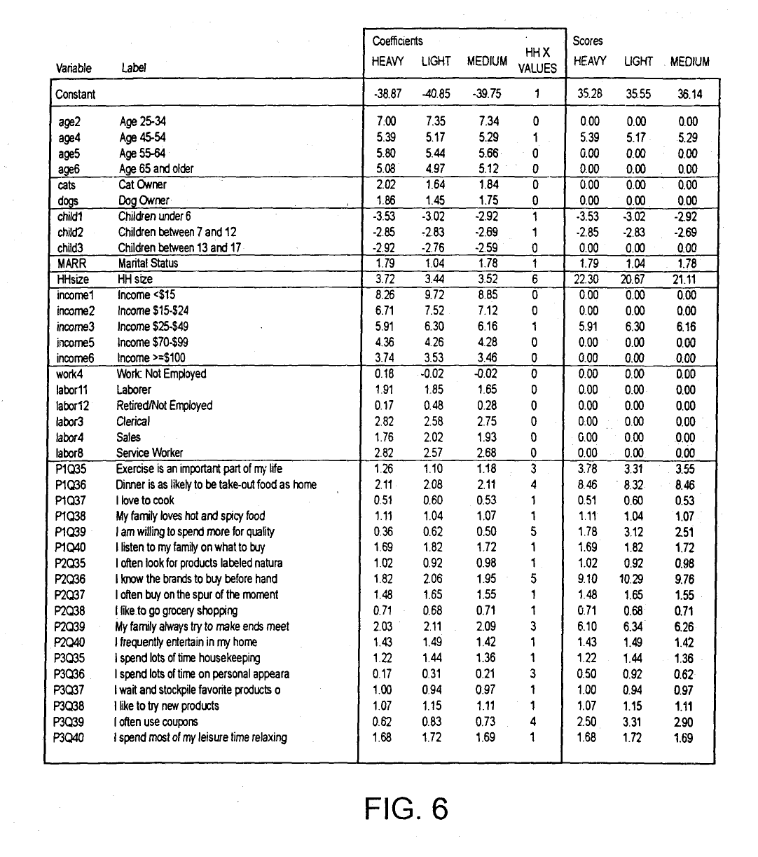

Based on the foregoing, to calculate each of the classification function values, the system multiplies each of the numerical values corresponding to the answers provided by the consumer by a coefficient stored in the third memory 32 of the system 20. This is shown as a step 52 in FIG. 3. Different sets of coefficients are used for each of the eleven classification functions. Moreover, not all of the questions, and their corresponding numerical values, need be used for each of the classification functions. For example, as depicted in the spread sheet of FIG. 6, the answers to only some of the questionnaire questions, and their corresponding numerical values are used in calculating the “meta” classification functions. It can then be seen that coefficients corresponding to each question and each category are multiplied by the set of numerical values corresponding to the given question (identified in the spreadsheet under the heading “HH X Values”) to arrive at various multiplication products or scores.

While not depicted in the spreadsheet, in accordance with the step 50, each of the heavy, light and medium score columns are then summed as indicated by a step 54, with a known constant then being added to each of the multiplication products or scores to arrive at the classification function value, as indicated by a step 56. Similar calculations are performed for each of the eleven classification functions using the appropriate questions, coefficients, and constants.

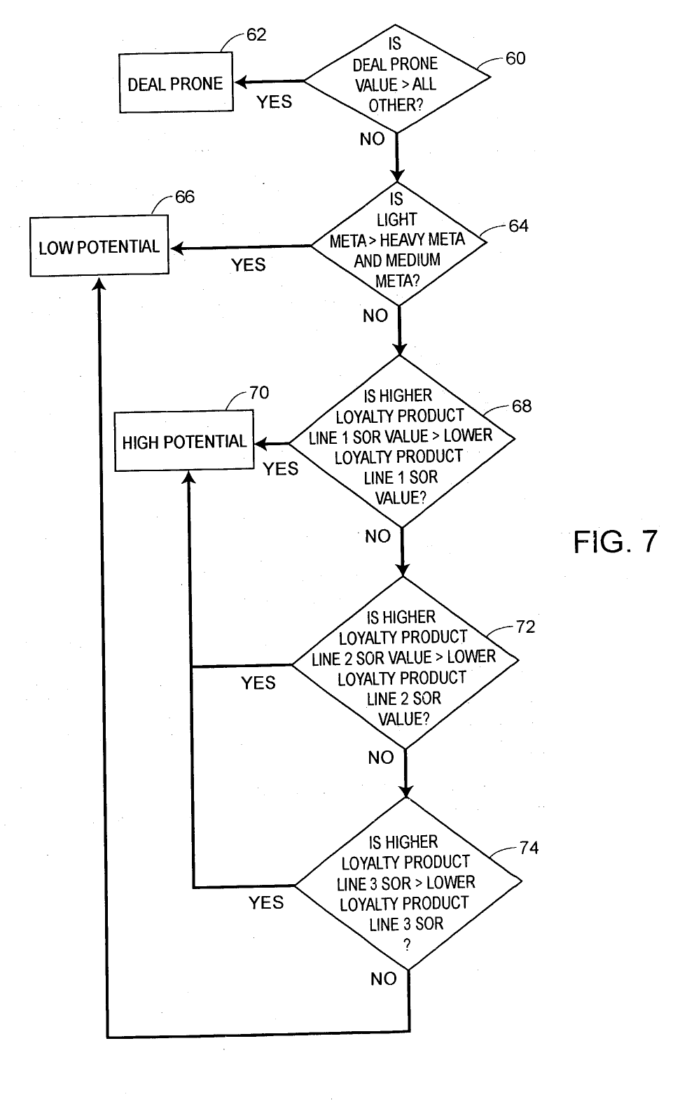

Based on the foregoing, it can be seen that at the end of such calculations, eleven different sets of classification function values will have been calculated. As indicated in step 58, those values are then compared to determine which of the three consumer categories applies to the consumer in question. More specifically, as shown in FIG. 7, which specifies possible sub-steps involved in step 58, a step 60 compares the classification function value for the deal prone classification function to the classification function value for the not deal prone function. If the numerical value is greater for the deal prone classification function value, the person is declared a deal prone consumer as indicated in step 62. However, if the not deal prone classification function value is less, further comparisons are required. More specifically, as indicated in the step 64, the light meta classification value is then compared to the heavy and medium meta classification function values and if the light meta classification function value is determined to be greater than both, the consumer is declared to be a low potential consumer as indicated in step 60.

If not, further comparisons are required. For example, as shown in step 68, the higher loyalty product line 1 SOR classification function value is compared to the lower loyalty product line 1 SOR value, and if the higher loyalty product line 1 SOR value is greater, the consumer is classified as a high potential consumer as indicated in a step 70. Otherwise, a further comparison is performed, wherein the higher loyalty product line 2 SOR value is compared to the lower loyalty product line 2 SOR value as indicated by a step 72, and if the higher loyalty value is greater, the consumer is classified as a high potential consumer as well, again indicated by the step 70. Alternatively, if the lower loyalty product line 2 SOR value is determined to be less, a still further comparison is performed wherein the higher loyalty product line 3 SOR value is compared to the lower loyalty product line 3 SOR value, as indicated by a step 74. If the higher loyalty product line 3 SOR value is determined to be higher, again the consumer is classified as a high potential consumer, but, if not, the consumer is classified as a low potential consumer.

In so doing, it can be seen that based on such gathering of information, calculations, and comparisons, all consumers using the system can be ultimately categorized into one of the three consumer categories: deal prone, high potential, and low potential. Once the consumers are so categorized, the system can then identify an advertisement which is best suited to maximizing the potential of gaining the business of the consumer. The proper advertisement can then be transmitted by electronic mail directly to the consumer. This can be done immediately upon the user completing the questionnaire and when the user is still on-line, or the user can provide his or her electronic mail address such that the advertisements or other advertisements can be transmitted to the consumer at a later date by recalling the address from the database of the sixth memory. Rather than identifying the appropriate advertisement to transmit, a single advertisement may be generated but only transmitted to those of the high potential category. Alternatively, a second advertisement including price incentives, discounts or the like could be transmitted to those of the deal prone category as well.

What is claimed is:

1. A method of determining the buying profile of a consumer, comprising:
asking a series of questions of a consumer, each of the questions being asked and answered electronically;
assigning a numerical value to each of the answers;
multiplying each numerical value by one of a plurality of coefficients to arrive at a product, each coefficient being associated with a particular question and one of a plurality of classification functions;
adding the products associated with each classification function together to arrive at a plurality of classification function sums;
adding a constant to each of the classification function sums to arrive at a plurality of classification function values; and
comparing the classification function values to determine the buying profile of the consumer.

2. The method of claim 1, wherein the comparing step results in the consumer being classified into one of the group of categories consisting of deal prone, high potential, and low potential.

3. The method of claim 1, wherein the consumer questions include demographic questions.

4. The method of claim 1, wherein the consumer questions include attitudinal questions.

5. The method of claim 1, wherein the plurality of classification functions include deal prone, not deal prone, heavy meta user, low meta use, medium meta user, high product line 1 SOR, low product line 1 SOR, high product line 2 SOR, low product line 2 SOR, high product line 3 SOR, and low product line 3 SOR.

6. The method of claim 2, further including the step of disseminating an advertisement to the consumer based on which of the deal prone, high potential, and low potential categories is identified as being the category under which the consumer qualifies.

7. A marketing method, comprising:
having consumers complete an on-line questionnaire;
classifying each consumer into one of a plurality of categories based on answers received in response to the questionnaire;
preparing an advertisement specific to each category; and
disseminating the advertisement specific to each category of consumer via electronic mail.

8. The marketing method of claim 7, wherein the classifying involves assigning a numerical value to each answer and multiplying each answer by a known coefficient to arrive at a product.

9. The marketing method of claim 8, wherein the classifying further involves adding all products together associated with one of a plurality classification functions and then comparing sums resulting from the adding.

10. The marketing method of claim 9, wherein the adding further involves adding a constant to each of the classification function sums.

11. The marketing method of claim 7, wherein the plurality of categories include deal prone, high potential, and low potential consumers.

12. The marketing method of claim 7, wherein the on-line questionnaire includes attitudinal and demographic questions.

13. The marketing method of claim 12, wherein the attitudinal questions include those related to willingness to spend more for quality, involvement with caring for a house, openness to family suggestions about products to buy, and loyalty to specific brands.

14. The marketing method of claim 12, wherein the demographic questions include those related to pets, household size, age, and income.

15. The marketing method of claim 7, wherein the classifying is performing electronically.

16. A marketing system, comprising:
a web server adapted to interact with on-line consumers;
a first memory operatively associated with the web server and having a consumer questionnaire store therein;
a second memory operatively associated with the web server and having classification software stored therein;
a third memory operatively associated with the web server and having a plurality of coefficients stored therein, and
a processor operatively associated with the web server, first memory, second memory and third memory, the processor adapted to receive signals from the web server associated with answers provided by on-line consumers in response to the questionnaire stored in the first memory, and execute the software stored in the second memory using the coefficients stored in the third memory to classify the consumer into one of a plurality of consumer categories.

17. The marketing system of claim 16, further including a fourth memory having a plurality of numerical constants stored therein.

18. The marketing system of claim 16, further including a fifth memory having a plurality of advertisements stored therein, the processor and web server being adapted to disseminate one of the advertisements stored in the fifth memory to the on-line consumer.

19. The marketing system of claim 16, further including a sixth memory adapted to store electronic mail addresses of on-line consumers.

20. The marketing system of claim 16, wherein the processor and web server are provided in an integrated computer device.

21. A marketing method, comprising:
receiving information regarding an individual consumer;
performing a series of arithmetic functions based on the received information;
comparing and contrasting values obtained from the arithmetic functions to determine whether the consumer is one of a high potential consumer, low potential consumer, and deal prone consumer; and
transmitting an advertisement to the consumer if the consumer is one of a high potential consumer and deal prone consumer.

22. The marketing method of claim 21, wherein the information is received by way of a questionnaire.

23. The marketing method of claim 22, wherein the information questionnaire is provided and answered electronically.

24. The marketing method of claim 21, wherein the arithmetic functions include assigning numeric values to answers provided in response to the questionnaire, and multiplying the numeric values by a series of coefficients.

25. The marketing method of claim 24, wherein the arithmetic function further includes adding a constant to products obtained from multiplying the numeric values by the series of coefficients.
